(19) United States
(12) Patent Application Publication
(10) Pub. No.: US 2026/0021410 A1
(43) Pub. Date: Jan. 22, 2026

(54) LLM-BASED AUDIO SURFACING OF PERSONALIZED GAME RECOMMENDATIONS

(71) Applicant: Sony Interactive Entertainment Inc., Tokyo (JP)

(72) Inventors: Jason Grimm, San Mateo, CA (US); Alex Paiz, San Mateo, CA (US); Yuhei Taki, San Mateo, CA (US)

(21) Appl. No.: 18/779,565

(22) Filed: Jul. 22, 2024

(51) Int. Cl. A63F 13/67

(52) U.S. Cl. CPC A63F 13/67

(57) ABSTRACT

Artificial intelligence (AI) models are disclosed to generate unique, personalized podcasts that include recommendations of other games that a particular gamer might want to play. The podcasts can present the recommendations in a voice of a video game character of a video game already played by the respective gamer.

### FIELD

The disclosure below relates to technically inventive, non-routine solutions that are necessarily rooted in computer technology and that produce concrete technical improvements. In particular, the disclosure below relates to artificial intelligence (AI) models that surface game recommendations to different gamers in personalized podcasts.

### BACKGROUND

As recognized herein, video game platforms currently lack the ability to provide unique and targeted content to gamers to update the gamers about things that are happening on the platform. There are currently no adequate solutions to the foregoing computer-related, technological problem.

### SUMMARY

Accordingly, in one aspect an apparatus includes at least one processor system programmed with instructions to execute a model to identify a first video game to recommend to a video game player, with the first video game being one not yet played by the video game player. Based on the identification, the at least one processor system is programmed with instructions to generate a podcast in a voice of a video game character of a second video game already played by the video game player, with the podcast discussing the first video game.

In various examples, the model may identify the first video game based on the first video game being similar to the second video game, based on the video game player's playstyle, based on the first video game being in a same game genre as one or more other video games played by the video game player, and/or based on the first video game being in a group of video games that a game platform has indicated for recommendation to video game players.

Also in various examples, the podcast may be generated to discuss the first video game at greater length than a third video game also discussed in the podcast, and/or to discuss the first video game before the third video game as also discussed in the podcast. The third video game may be the second video game or may be a different video game. Additionally, the podcast may be generated to verbally recommend that the video game player play the first video game.

In various example implementations, the podcast may include audio and even video showing the video game character discussing the first video game.

Additionally, in some cases the at least one processor system may be programmed with instructions to execute a generative artificial intelligence (AI) model to generate the podcast, and to present the podcast at a device associated with the video game player.

In another aspect, a method includes identifying a first video game to recommend to a video game player, with the first video game being one not yet played by the video game player. The method also includes, based on the identification, generating audio in a voice of a video game character of a second video game already played by the video game player, with the audio discussing the first video game.

In some specific examples, the first video game may be identified based on the first video game being similar to the second video game, based on the video game player's playstyle, and/or based on the first video game being in a same game genre as one or more other video games played by the video game player. Additionally or alternatively, the first video game may be identified based on the first video game being in a group of video games that a game platform has indicated for recommendation to video game players.

In still another aspect, at least one computer readable storage medium (CRSM) that is not a transitory signal includes instructions executable by a processor system to identify a first video game to recommend to a video game player, with the first video game being one not yet played by the video game player. The instructions are also executable to, based on the identification, generate audio in a voice of a video game character, with the audio discussing the first video game.

In certain examples, the video game character may be a first video game character, the first video game character may be a character from a second video game already played by the video game player, and the audio may include a dialogue about the first video game. The dialogue may be between the first video game character and a second video game character of a third video game played by the video game player. The dialogue may be personalized to the video game player according to data associated with the video game player.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows an example platform home screen that includes selectors to watch or listen to a personally-tailored, generative AI podcast consistent with present principles;

FIGS. 3 and 4 show illustrations of a video game player observing the personally-tailored, generative AI podcast consistent with present principles;

FIG. 5 shows example logic in example flow chart format that may be executed by a system/apparatus consistent with present principles;

FIG. 6 shows example artificial intelligence (AI) architecture that may be used consistent with present principles; and

FIG. 7 shows an example settings graphical user interface (GUI) that may be used to configure one or more settings of a system/apparatus to operate consistent with present principles.

### DETAILED DESCRIPTION

The detailed description below provides technical systems and methods for generating personalized podcasts and/or other audio video content to present to a given video player. The podcast can be used to surface news about games the player cares about. The games can be games the player has played recently, different/new games of a same game genre as other games played by the player, and/or games that the player's friends have played recently. The generative podcast can be configured like a newscast that is spoken by a main character of recent game played by the player. The podcast can be generated based on game platform website data, blogs, player-specific gameplay data, etc. The podcast can even be a dialogue between two characters from the same game or different games that the player likes to play. The podcast can also give game-specific recommendations on how to play the game. Voices of different characters can be rotated in and out for subsequent podcasts.

Additionally, in some examples, if the gaming platform wants to highlight specific games for players to experiment with, the podcast can suggest different games to different players based on a cluster to which the relevant player is assigned. These game recommendations can also be provided in the generative AI podcasts, in game-specific character voices no less. Recommendations may be prioritized and jump out a little more to the listener to get the listener to note the recommendation. Prioritization may be based on where the recommendation is placed in the podcast (e.g., the first one mentioned) and the length of the audio for the recommendation compared to the length of audio for other aspects of the podcast.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

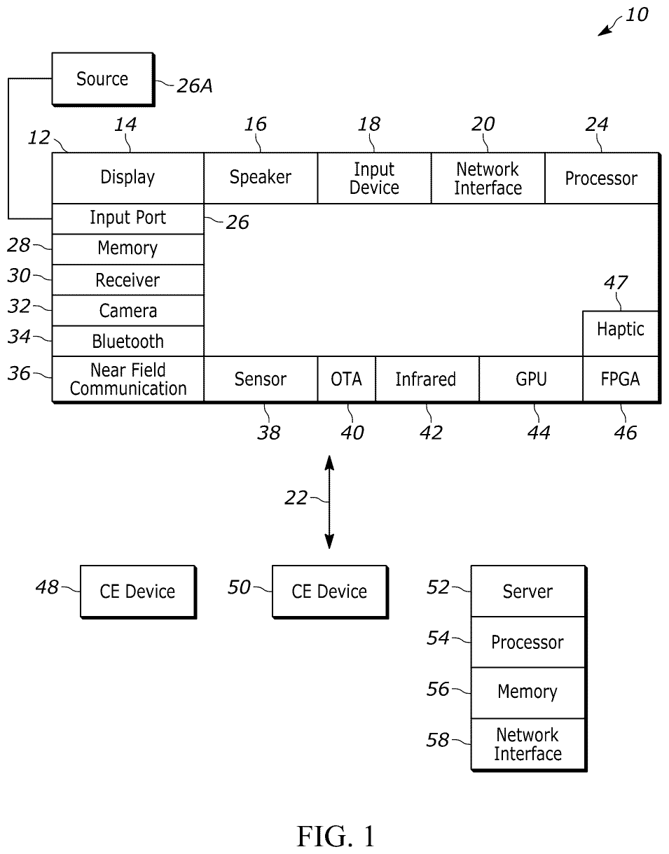

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

Also note before describing other figures that selectors and options on the GUIs discussed below may be selected via cursor input, touch input to the touch-enabled display on which the GUI is presented, using voice input, and/or using other input methods.

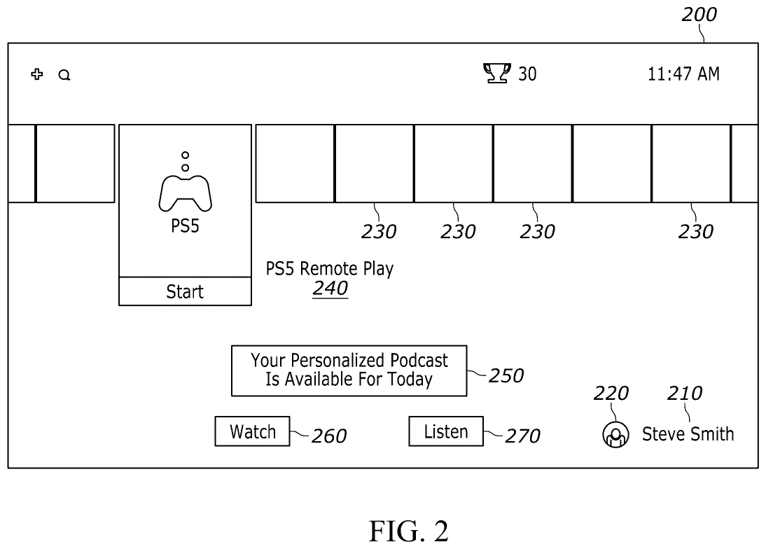

Now in reference to FIG. 2, suppose a first video game player has started up his/her video game console (or other device), or awoken it from a sleep state, to play video games through the console. The video games themselves might be locally stored and executed by the console, and/or may be streamed over the Internet from a cloud server. In either case, an example home screen graphical user interface (GUI) 200 may be presented on the user's local display as connected to the console/server.

As shown in FIG. 2, the GUI 200 indicates a profile name 210 and profile avatar 220 for a digital profile of the first video game player. The GUI 200 also includes selectable video game images 230 for video games played by the first video game player, as associated with the player's profile. Other images may also be included in the same list, including a selectable image 240 to initiate remote play with other remotely-located video game players.

Additionally, the GUI 200 may include a prompt 250 and selectors 260, 270. The prompt 250 and selectors 260, 270 may be presented responsive to a trigger, such as the console being used a first time and/or the profile being accessed a first time within a 24-hour period. Another trigger may be the console being used a first time and/or the profile being accessed a first time on a given calendar day.

As shown in FIG. 2, the prompt 250 may indicate that a personalized, unique, daily podcast specifically tailored for the first video game player is available for viewing. The selector 260 may be selectable by the first video game player to command the console/server to present the associated podcast's audio with accompanying video. The selector 270 may be selected by the first video game player to command the console/server to present the associated podcast's audio without video.

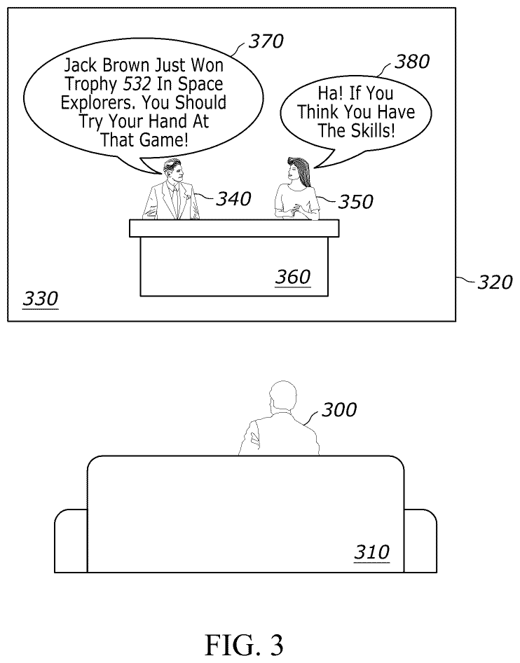

FIG. 3 further illustrates. Here, the first video game player has selected the selector 260 and, in response, the console/server begins presenting the audio for the podcast along with video that was also generated for the podcast. As such, the first video game player 300 sits on a couch 310 while hearing the podcast's audio being played out over speakers on a television 320. The player 300 is also shown viewing the podcast's accompanying video 330 as played out on the display of the television 320.

In the example of FIG. 3, two video game characters 340, 350 are shown. Each character 340, 350 is a main character from a different video game that the first video game player has already played (in whole or in part). In some examples, the characters 340, 350 may be from the two most-recently played video games played by the first video game player using the first player's profile. The first video game character 340 is a Roman soldier from a first video game according to this example, and the character 350 is a bunny from a second, different video game according to this example. But note that both the audio and video 330 are not sourced directly from the original game content itself (for either game), but rather have been generated using a generative artificial intelligence (AI) model. Accordingly, while the characters 340, 350 have the same visual likeness as in their associated games, and the tailored audio of their voices sounds the same as in their respective games, the audio and video content as shown in FIG. 3 establishes a new generative dialogue between the two that was not sourced from the games themselves.

More specifically, the AI-generated audio and video may be uniquely tailored and personalized to the first video game player, with the characters 340, 350 sitting behind a virtual news desk 360 in a virtual studio. The characters 340, 350 are also shown holding pieces of paper with “news” written on them, even though this scene was not part of the original game content from either game itself.

As also shown in FIG. 3, as part of the podcast, the characters 340, 350 begin discussing gamer news that has been tailored and personalized to the first video game player themselves. As such, speech bubble 370 illustrates that the audio of the podcast includes the character 340 verbally and audibly discussing news about a connection of the first video game player, with the connection being a friend of the first video game player according to the first video game player's online gamer network (as tied to the first video game player's profile). In the present instance, the audio includes the character 340 saying, “Jack Brown just won trophy 532 in Space Explorers. You should try your hand at that game!” It may therefore be appreciated from this audio that one example output of an AI model used to generate news podcasts consistent with present principles may include a discussion of a third video game to verbally recommend to the first video game player, with the recommended (third) video game being one not yet played by the first video game player as determined from the player's profile data.

However, further note that the example audible output may also be synthesized into a single statement or sentiment with other news of interest to the first video game player, including other gameplay news related to gameplay of the player's connection. In the present example, the news related to gameplay of the player's connection includes “Jack Brown” playing Space Explorers, where Space Explorers is the (third) video game not yet played by the first video game player. Or in other examples, the gameplay news may relate to a fourth video game already played by the first video game player, but not a most-recently played game, to thus entice the first video game player to begin playing the fourth game again. Either way, in various examples the gameplay news might indicate that the player's connection has been playing the other video game in single player mode, that the connection participated in teamplay in the other video game, that the connection just started playing the other video game for the first time, or even that an achievement was obtained via the other video game by the connection. Example achievements may include passing a level of the other video game and progressing on to the next level, beating a boss or other opponent within the game, achieving a certain amount of virtual currency in the game, or, in the present instance, being awarded a trophy in the game.

As also shown in FIG. 3, the characters 340, 350 may continue to discuss the verbally recommended (third) video game itself, with speech bubble 380 representing that the character 350 audibly dialogues with the character 340 by making a joke at the first video game player's expense (exclaiming “Ha! If you think you have the skills.”). The generative AI model may thus generate and inject good-natured jokes into the dialogue to hopefully entice the first video game player to try the new, recommended game.

Turning to FIG. 4, the same personalized audio podcast from FIG. 3 with accompanying video (presented concurrently with the audio) may continue to be presented to the player 300. After discussing the recommended third video game first before discussing other video games, and discussing the third game at greater length than other video games will be discussed to entice the first video game player to try the recommended game that the player has not played yet, speech bubble 400 indicates that the character 340 may subsequently discuss a software update for one of the video games (“Gen X”) that the first video game player has already played (again as determined from the first video game player's profile). In the present instance, the character 340 verbally says, “In other news, there's a software update for Gen X, so update now.” This may help remind the first video game player to update the Gen X game immediately rather than having to do so when the player actually wants to play that game (and having to wait for the update to be completed as a result). Also note that other types of software updates may also be discussed by the characters 340, 350, such as a console software update or even a television operating system update in embodiments where the console/server has access to the television's operating system (or other connected device's operating system).

The audible dialogue between the characters 340, 350 may continue after that, if desired. As an example, in the present instance and as also shown in FIG. 4, the character 350 may verbally recommend a game action for the first video game player to take in the Gen X video game. Here, that includes the character 350 indicating, “Also, try a spin move on the boss next time!” Other example actions that may be recommended include a jump action, exploring a certain area of a virtual world of the video game, finding a hidden potion or treasure, etc.

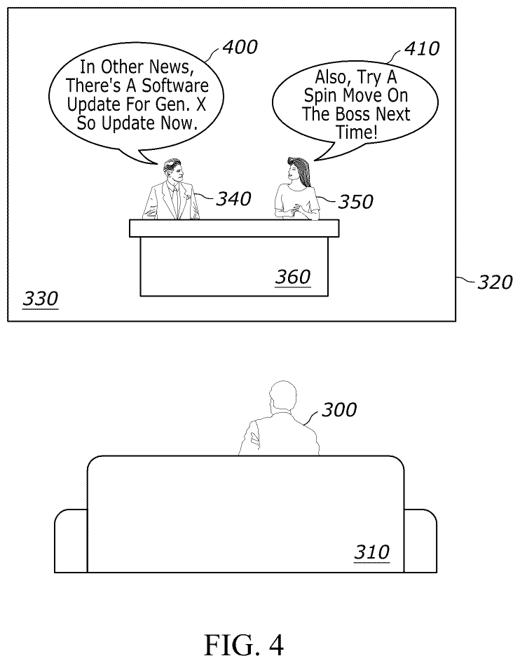

Before moving on to the description of FIG. 5, also note with respect to FIGS. 3 and 4 that although the speech bubbles shown in these figures represent audio from the podcast that is generated and then played out to the player 300 through speakers, in some examples the speech bubbles themselves (and accompanying text) may be visually presented as shown in these figures. This may be done to assist hearing-impaired users and others.

Now in reference to FIG. 5, this figure shows example logic that may be executed by an apparatus such as the CE device 12 (e.g., console) and/or server 52 alone or in any appropriate combination. Thus, in some examples the logic may be executed by a client device alone. In other examples, the logic may be executed by a client device and remotely-located server, where the client device offloads some or all of the logic to the server. Further note that while the logic of FIG. 5 is shown in flow chart format, other suitable logic may also be used.

Beginning at block 500, the apparatus may access first data associated with a first video game player's profile. The apparatus may do so responsive to the first video game player logging in to the player's profile, responsive to the player starting or providing commands to the apparatus (e.g., console) a first time on a given calendar day, responsive to a new calendar day starting according to the user's local time, etc. The first data from the profile may include a number of different things, including a history of different video games played by the first video game player while logged into the profile, all connections (e.g., human “friends”) of the first video game player as connected through respective platform profiles for the players, achievements the first video game player has achieved in one or more games as represented in the profile, game interests and preferences of the first video game player as input by the player themselves and/or determined by the system, voice chats and text chats in which the first video game player has engaged using the profile and/or video game platform, length of time a given video game has been played by the player, level reached in a given video game that has been played by the player, etc.

From block 500 the logic may then proceed to block 510. At block 510 the apparatus may process the first data using a large language model (LLM) to identify relevant second data for a podcast or other personalized recording that will be generated for the player. However, also note that in addition to or in lieu of using an LLM, other types of software may be used, including natural language processing and other types of AI models. Either way, at block 510 the model(s) or other software may be executed to identify certain (second) data associated with the first video game player's profile through the first data itself. Thus, the LLM may be executed to identify the second data from outside the profile using the first data from in the profile, correlating the second data to the first data.

For example, the first data may indicate a connection of the first video game player and a video game played by both the first player and the connection, with the LLM then being executed to search game network data to generate text for game trends or game accomplishments of the connection (the second data in this example), which may then be reported to the first video game player as part of the generative podcast.

As another example, the first data may indicate interests or preferred game genres for the first video game player, and the LLM may then search game network data and generate text for the podcast that indicates different games associated with the same interests or genre but that have received acclaim or criticism from other players on the game network. The acclaim or criticism (second) data may be determined from Internet-accessible publications such as gamer blog posts, video blogs, press releases from game developers and console manufacturers, etc.

As yet another example, the LLM may identify software updates (the second data here) from the gaming platform's server based on games associated with the first video game player's profile (the first data here) to generate text indicating the update(s).

As still another example, the LLM may identify the first video game player's preferred moves or playstyle for one game or video games generally (the first data) to then to look for tips and similar moves to recommend as part of a podcast. Additionally or alternatively, different moves/gameplay styles may be recommended to help the player expand his/her gaming abilities.

Notwithstanding the foregoing, further note that in certain examples the first data itself may establish some or all of the second data. For example, the LLM may lookup gameplay history data for the first video game player as stored in the first player's profile and, responsive to determining that a certain game the first player used to play in the past has not been played for at least a threshold amount of time (e.g., one month), the LLM may generate text recommending the first player play that game again. This text and/or other text mentioned in the paragraphs above may then be used to generate audio for presentation to the first player as part of the podcast (e.g., using a text-to-speech algorithm).

As but one more example, the LLM may lookup game moves the first video game player has performed in the past but that the first player has not tried in a most-recently played video game, with the moves being the first data indicated in the first player's profile data here. The LLM may then generate text suggesting those previous moves again for use in the most-recently played game to help the player beat a boss in the most-recently played game.

From block 510 the logic may then proceed to block 520. At block 520 the apparatus may access platform data regarding featured games. The platform data/featured games may have been uploaded or otherwise specified by a particular gaming platform, such as Sony PlayStation®. The platform data may relate to games that the platform wishes to highlight to gamers for play. So at block 520, the apparatus may access the platform data as stored at a game network server to then parse the platform data for one or more games to recommend to the first video game player as part of the podcast. The game(s) selected from the platform data for recommendation to the first player may be agnostic to the first player and, as such, may simply be games specified by the platform for recommendation to all gamers. Or in other examples, a certain game may be selected from among others indicated in the platform data based on one or more factors related to the first player themselves. For example, the apparatus may identify a given video game for recommendation based on that video game being similar to another game the first video game player has already played. Similarity may be deduced from similar titles for the games, similar characters for the games, the recommended game being a subsequent version of the already-played game, or even the recommended game being assigned a same game genre as the already-played game (as indicated in metadata for the recommended game). Example video game genres include adventure, fighting, simulation, action, puzzle, role playing game, first person shooter, and e-sports.

The game that is identified for recommendation from the platform data may be identified still other ways as well. For example, the apparatus may identify the first video game player's playstyle, as determined by the gaming platform and noted in the first video game player's profile. Example playstyles include slow, fast, passive, aggressive, conservative, risk-taking, skilled in special moves, skilled in discovering hidden treasures, etc. The apparatus may then correlate the first player's playstyle to a game for recommendation, with the metadata for the recommended game indicating particular playstyles that work well when playing the recommended game. Among those playstyles in the metadata may be the same one identified from the first player's profile for the apparatus to thus identify the associated game as one to recommend. Also note here that the first player's playstyle itself may be identified by the platform or apparatus using various clustering algorithms, where game moves of the first player are compared against game moves of other players in different playstyle clusters to assign the first player's playstyle to a given cluster for the same playstyle as the first player themselves.

From block 520 the logic of FIG. 5 may then proceed to block 530. At block 530 the apparatus may use one or more generative AI models to generate a podcast (or other audio and accompanying video) of news derived from or otherwise based on the second data. As indicated above in reference to FIGS. 3-4, the podcast may present the news in the voice of one or more video game characters of one or more video games already played by the first video game player. The news may indicate items that the apparatus has determined to be of interest to the first video game player, and even include recommendations of other video games for the first video game player to play as set forth above.

Additionally, to highlight the recommended game amidst other personalized news presented to the first video game player through the podcast, the generative AI model may configure the podcast to discuss the recommended video game first and/or at greater length than other videos games that might also be discussed in the podcast, including another game that is already being played by the first video game player.

From block 530 the logic may then proceed to block 540. At block 540 the apparatus may present the podcast at a device associated with the first video game player, such as a combined display/speaker device (e.g., television), laptop computer, smartphone, dedicated hand-held gaming device, etc.

After block 540 the logic may proceed to block 550. At block 550 the apparatus may revert back to block 500 to generate another podcast based on one or more of the triggers mentioned above, rotating game characters that dialogue as part of the next podcast. The rotation to other characters may be based on other games the player might have played the day prior, so that the next podcast has characters derived from a most-recently played game, whatever that game might be. Additionally or alternatively, the rotation may be to other characters from within the same game that was used to source the immediately prior podcast's characters, keeping the podcasts fresh with each one through different characters even if the player plays the same game over and over again over the span of multiple days.

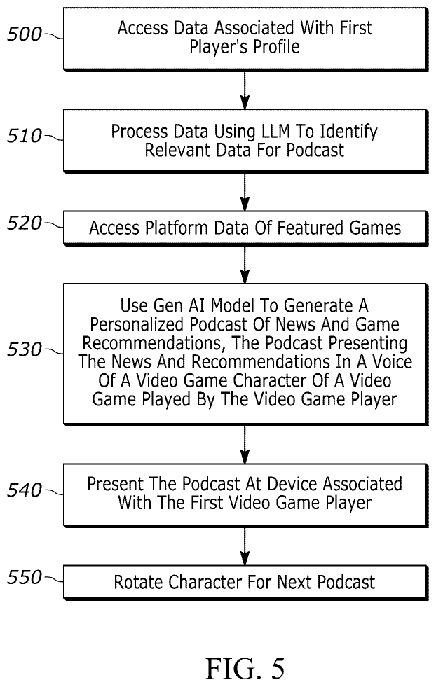

Turning now to FIG. 6, example artificial intelligence (AI) model architecture 600 is shown that may be implemented consistent with present principles. The architecture 600 may be constructed with a first model 610 that includes one or more LLMs (e.g., generative pretrained transformers) and/or other machine learning-based models for identifying relevant, personalized content to present to a video game player as podcast news. Thus, in addition to or in lieu of an LLM, the model 610 may be established by one or more artificial neural networks (ANNs) such as one or more convolutional neural networks (CNNs) in particular. The LLM, CNN, and/or other AI-based model 610 may be trained to make inferences of relevant content to present to a given user based on profile data associated with (e.g., correlated to) the relevant content. So, for example, the model 610 may be trained in supervised fashion using a dataset that includes pairs of relevant content and associated ground truth labels for associated profile data. Unsupervised learning, semi-supervised learning, reinforcement learning, and other learning techniques may additionally or alternatively be used to train the model 610.

FIG. 6 also shows that the architecture 600 may include a second model 620 different from the first model 610. The second model 620 may be a generative AI model such as a deepfake generator or other audio/video generation model. The first LLM/model 610 might therefore output news text based on content it has identified as relevant to the player, with the second model 620 then converting the text to audio using a text-to-voice algorithm for the generated audio to be read/spoken aloud as part of a podcast.

One or more text-to-video models may also be used as part of the generative model 620. Those models may include pre-trained transformer models, video diffusion models such as full latent diffusion models and other types of diffusion models, and/or an encoder-decoder model and a transformer model in combination. Generative adversarial networks (GANs) such as Deep Convolutional Generative Adversarial Networks (DCGANs) may also be used, as well as still other generative video models. Thus, the text output by the first model 610 may be fed into one of these text-to-video models to then generate video based on the input text so that for the generated video can be presented concurrently with and match the generated audio.

Providing specific examples of deepfake generators that may be used for the model 620 consistent with present principles, DeepFaceLab may be used, as may DTS and Roop. Other deepfake generators may also be used. The deepfake generator may be trained to generate deepfake audio in the voice of video game characters, and to generate deepfake video in the likeness of video game characters. To train the generator, the generator may be provided audio-video clips of different video games, with each clip containing audio of a particular game character speaking and video showing the appearance/likeness of the same character. Each clip may have a label attached that indicates the name of the associated character shown in the respective clip. The deepfake generator may then be trained using the clip/label pairs to generate other audio for a given character that includes different words never spoken by the character in the actual game itself, and to generate video of the character that includes actions the character never actually performed in the game itself.

Describing an example use of the architecture 600, note that profile data 630 may be fed into the first model 610 as input for the first model 610 to then determine relevant content according to the player's profile data. An inference 640 of relevant, personalized content may then be output by the model 610. The output 640 may then be fed into the second model 620 for the second model 620 to generate deepfake audio and/or deepfake video 650 for presentation to the player at the player's client device.

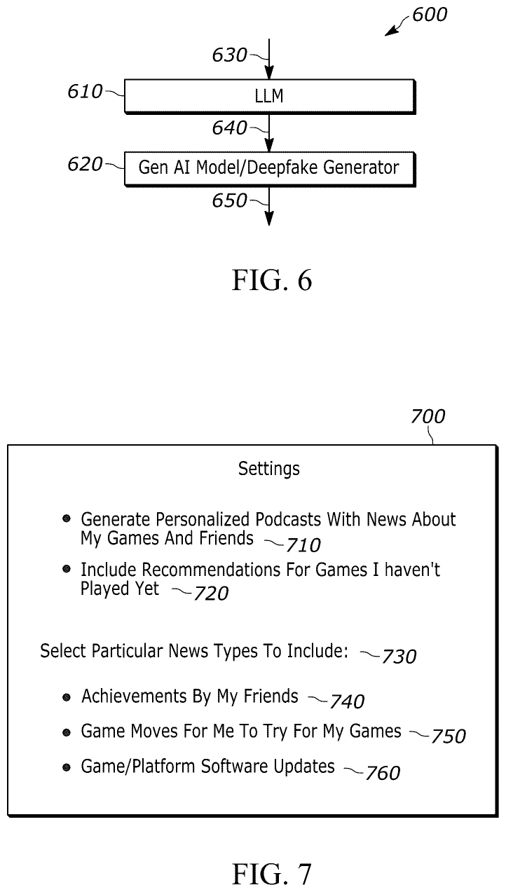

Continuing the detailed description in reference to FIG. 7, it shows an example GUI 700 that may be presented on a display for an end-user to configure one or more settings of an apparatus to operate consistent with present principles. The GUI 700 may be presented as part of a console operating system settings screen, for example.

As shown in FIG. 7, the GUI 700 may include a first option 710 that is selectable to set or enable the apparatus to generate personalized podcasts with news about a given human player's games and platform-connected friends. Therefore, the option 710 may be selected a single time to set or configure the apparatus to, for multiple future instances, undertake one or more of the actions set forth above in reference to FIGS. 2-6 to generate and present podcasts/other personalized audio.

The GUI 700 may also include an option 720. The option 720 may be selectable to specifically set or enable the apparatus to include, in the podcasts, recommendations of games that the player has not played yet. Those games might have been specified for recommendation by a gaming platform as set forth above.

The GUI 700 may also include a setting 730 at which the user can select one or more particular types of news/content to include in the user's personalized podcasts. Any of the types discussed herein may be listed for the setting 730, but for simplicity only three are shown in FIG. 7. Accordingly, option 740 may be selected to select achievements by the player's friends for inclusion in the podcasts. Option 750 may be selected to select game moves for the player to try for the player's own games for inclusion in the podcasts. Option 760 may be selected to select game and/or console software updates for inclusion in the podcasts.

It may now be appreciated that present principles provide for the use of LLMs and other AI-based models to surface news about games a video game player cares about, including games the player has played recently. The newscasts may be given by main characters of a recent game played by the player. The AI model may do its querying on the back end, using websites, blogs, etc. for identifying news to provide, and then use a generative model for voice and also for surfacing video corresponding to the podcast audio. The podcast characters may even make jokes and pithy comments directed at the particular player to which they are presented. The podcast characters may also recommend in-game actions for the player to take in the player's favorite video games, helping the player play the game more effectively. Each podcast that is generated for a given player may be dynamically created and personalized in terms of the substance of its message. Characters may even be rotated in and out for different podcasts that are presented to the player. The character voices and visual appearances that are used may be generated using deepfake technology.

What's more, in some specific instances, other games that a platform wants to highlight to its players may be recommended to the players themselves through the characters of the podcasts. These recommendations may even be prioritized in the podcast that is generated in terms of being presented first before discussion of other games and having content related to the recommended games occupying more of the playtime of the podcast than other aspects of the podcast.

While the particular embodiments are herein shown and described in detail, it is to be understood that the subject matter which is encompassed by the present invention is limited only by the claims.

What is claimed is:

1. An apparatus, comprising:
at least one processor system programmed with instructions to:
execute a model to identify a first video game to recommend to a video game player, the first video game being one not yet played by the video game player; and
based on the identification, generate a podcast in a voice of a video game character of a second video game already played by the video game player, the podcast discussing the first video game.

2. The apparatus of claim 1, wherein the model identifies the first video game based on the first video game being similar to the second video game.

3. The apparatus of claim 1, wherein the model identifies the first video game based on the video game player's playstyle.

4. The apparatus of claim 1, wherein the model identifies the first video game based on the first video game being in a same game genre as one or more other video games played by the video game player.

5. The apparatus of claim 1, wherein the model identifies the first video game based on the first video game being in a group of video games that a game platform has indicated for recommendation to video game players.

6. The apparatus of claim 1, wherein the podcast is generated to discuss the first video game at greater length than a third video game also discussed in the podcast.

7. The apparatus of claim 6, wherein the third video game is the second video game.

8. The apparatus of claim 1, wherein the podcast is generated to discuss the first video game before a third video game also discussed in the podcast.

9. The apparatus of claim 8, wherein the third video game is the second video game.

10. The apparatus of claim 1, wherein the podcast is generated to verbally recommend that the video game player play the first video game.

11. The apparatus of claim 1, wherein the podcast comprises audio.

12. The apparatus of claim 1, wherein the podcast comprises video, the video showing the video game character discussing the first video game.

13. The apparatus of claim 1, wherein the at least one processor system is programmed with instructions to:
present the podcast at a device associated with the video game player.

14. The apparatus of claim 1, wherein the at least one processor system is programmed with instructions to:
execute a generative artificial intelligence (AI) model to generate the podcast.

15. A method, comprising:
identifying a first video game to recommend to a video game player, the first video game being one not yet played by the video game player; and
based on the identification, generating audio in a voice of a video game character of a second video game already played by the video game player, the audio discussing the first video game.

16. The method of claim 15, wherein the first video game is identified based on one or more of: the first video game being similar to the second video game, the video game player's playstyle, the first video game being in a same game genre as one or more other video games played by the video game player.

17. The method of claim 15, wherein the first video game is identified based on the first video game being in a group of video games that a game platform has indicated for recommendation to video game players.

18. The method of claim 15, comprising:
presenting the audio at a device associated with the video game player.

19. An apparatus, comprising:
at least one computer readable storage medium (CRSM) that is not a transitory signal, the at least one CRSM comprising instructions executable by a processor system to:
identify a first video game to recommend to a video game player, the first video game being one not yet played by the video game player; and
based on the identification, generate audio in a voice of a video game character, the audio discussing the first video game.

20. The apparatus of claim 19, wherein the video game character is a first video game character, wherein the first video game character is a character from a second video game already played by the video game player, and wherein the audio comprises a dialogue about the first video game, the dialogue being between the first video game character and a second video game character of a third video game played by the video game player, the dialogue personalized to the video game player according to data associated with the video game player.
